(19) United States
(12) Patent Application Publication
(10) Pub. No.: US 2005/0172030 A1
(43) Pub. Date: Aug. 4, 2005

(54) Transmission method combining downloading and streaming

(76) Inventor: Laurent Fay, La Frette Sur Seine (FR)

Correspondence Address: PHILIPS INTELLECTUAL PROPERTY & STANDARDS, P.O. BOX 3001, BRIARCLIFF MANOR, NY, 10510, US

(21) Appl. No.: 10/510,251

(22) PCT Filed: Mar. 28, 2003
(86) PCT No.: PCT/IB03/01252

(30) Foreign Application Priority Data
Apr. 9, 2002 (EP) 02290889.1

(51) Int. Cl. G06F 15/16

(52) U.S. Cl. 709/234

(57) ABSTRACT

The invention proposes a method for transmitting a data file containing a content of known duration encoded at an encoding rate that is higher than the channel transmission rate. The proposed method comprises the steps of: downloading the data by using a transport protocol with rate control (like TCP) during a first period of time, and streaming the data by using a transport protocol without rate control (like UDP) during a second period of time. The second period of time (streaming) is proportional to the known duration of the content. Advantageously, the proportionality factor is equal to one. Application transmission of audio/video via Internet.

### FIELD OF THE INVENTION

The invention relates to a transmission system comprising a transmitter, a receiver having a content player, and a transmission channel between said transmitter and said receiver, said transmission channel having a channel transmission rate, said transmitter and said receiver supporting a transport protocol with rate control and a transport protocol without rate control.

The invention also relates to a transmitter and a receiver intended to be used in such a transmission system.

The invention also relates to a transmission method and a program comprising instructions for implementing such a transmission method.

The invention has interesting applications, notably for transmitting audio or video via the Internet.

### BACKGROUND OF THE INVENTION

As described in U.S. Pat. No. 6,029,200, two approaches may be used to transmit a multimedia content via an intranet or via the Internet. In the first approach, the multimedia content is downloaded, which means that it must be copied to the user before it can be played. In the second approach, the multimedia content is streamed, which means that it is supplied to the user as a continuous flow of data with little waiting time before playback begins. U.S. Pat. No. 6,029,200 describes a streaming system in which the transmitter and the receiver support various network transport protocols including UDP and TCP transport protocols, said various transport protocols being tried in a predefined order when attempting to start streaming.

These approaches have the following drawbacks:
The downloading approach introduces a latency at the user side (the user has to wait until the end of the transmission to start playing the data).
Transport protocols with rate control (like TCP) are not well suited to the streaming of audio/video data because the rate control may disturb the continuity of the rendering of the audio/video (if the transport protocol imposes an abrupt variation of the transmission rate, the receiver will not receive the data to be rendered in time, which will lead to an interruption in the audio/video rendering).
In order to successfully stream data using a transport protocol without rate control (like UDP), the encoding rate of the data shall not be higher than the transmission rate of the channel. When transmitting data via the Internet, the channel transmission rate notably depends on how the client is connected to the Internet (32 kbps or 56 kbps modem, ADSL . . . ). Typically, several data files are stored at the server side for the same content, each data file corresponding to a different encoding bit rate of the content. When requesting a content, the client has to indicate how he is connected to the Internet, which automatically designates the data file to be transferred. Thus, the encoding rate of the transmitted data file, and therefore the quality of the rendered content, is limited by the transmission rate of the Internet connection of the client.

It is an object of the invention to propose a transmission system, a transmitter, a receiver, a transmission method and a program for implementing a transmission method that do not have the above-mentioned drawbacks.

### SUMMARY OF THE INVENTION

A transmission system according to the invention comprises a transmitter, a receiver having a content player, and a transmission channel between said transmitter and said receiver, said transmission channel having a channel transmission rate, said transmitter and said receiver supporting a transport protocol with rate control and a transport protocol without rate control, said transmitter and said receiver being configured such that, for transmission from said transmitter to said receiver of a data file containing a content of known duration encoded at an encoding rate which is higher than said channel transmission rate, they use said transport protocol with rate control during a first period of time while storing the received data, and said transport protocol without rate control during a second period of time while playing the received data, said second period of time being proportional to said known duration, with a proportionality factor smaller than or equal to one.

The invention is a combination of the above-mentioned downloading and streaming approaches. During the first period of time, the data are downloaded, using a transport protocol with rate control (like the TCP protocol), and during the second period of time, the data are streamed, using a transport protocol without rate control (like the UDP protocol).

The channel transmission rate may vary in time depending on the congestion state of the transmission channel. The duration of the downloading period depends on the difference between the encoding rate of the data file to be transmitted and the channel transmission rate at the time of transmission (called effective channel transmission rate hereinafter).

Such a combination makes it possible to transmit a data file having an encoding bit rate that is higher than said channel transmission rate, and therefore to improve the quality of the rendered content.

The solution offered by the invention has the following advantages:
It limits the latency that is inherent in the downloading approach.
The transport protocol with rate control is used for downloading but not for streaming.
When the proportionality factor is equal to one, the second period of time is equal to the duration of the content. By doing so, the network resources are used in an optimal way (if the second period of time was shorter than the duration of the content, the available transmission time will not be fully used). As far as the state of the transmission channel does not significantly change during said second period of time, interruptions in the rendering are avoided (interruptions occur if the second period of time is longer than the duration of the content). When there is an important risk for the state of the transmission channel to change, the proportionality factor may be chosen smaller than one, to make sure that there will not be any interruptions in the rendering of the data.

In a first embodiment of the invention, the receiver is configured to send a request for a specific data file, and the transmitter is configured to:
calculate estimations of said channel transmission rate during said first period of time,
calculate estimations of said first period of time from said estimations of the channel transmission rate,
terminate said first period of time when the estimation of said first period of time is substantially equal to the time passed since the beginning of the transmission of said data file.

In this first embodiment, the data file to be transferred is specified by the client, and the transmitter calculates the duration of the downloading period depending on the effective channel transmission rate, so that the duration of the streaming period is proportional to the duration of the content.

In a second embodiment of the invention, the receiver is configured to send a request for a content, said request indicating an authorized latency time, and the transmitter is configured to:
send learning data to said receiver for calculating an estimation of said channel transmission rate,
select the data file to be transmitted, from said estimation of the channel transmission rate, and from said authorized latency time.

In this second embodiment, the client does not specify the data file to be transferred but the latency time he is accepting before starting the rendering of the data. The duration of the downloading mode shall be near the authorized latency time. The transmitter first has to make an evaluation of the effective channel transmission rate. Knowing the effective channel transmission rate, it then selects the data file of maximum encoding rate that can be transmitted with a duration of the downloading mode near the authorized latency time.

### BRIEF DESCRIPTION OF THE DRAWINGS

The invention will be further described with reference to the accompanying drawings:

FIG. 1 is a schematic representation of an example of a transmission system according to the invention,

FIG. 2 is a schematic representation of data exchanges in a transmission system according to the invention,

FIG. 3 is a diagram explaining the operation of the transmission system according to the invention,

FIG. 4 is a flow chart of an example of a transmission method according to the invention.

### DESCRIPTION OF PREFERRED EMBODIMENT

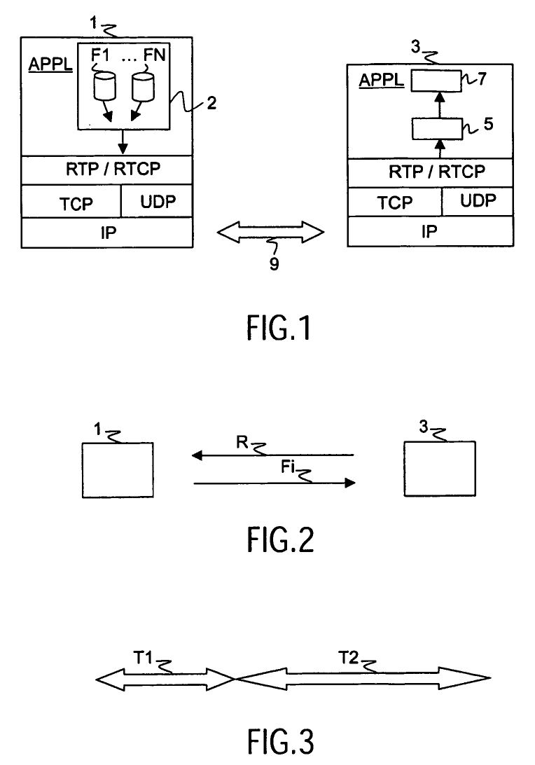

A schematic representation of a transmission system according to the invention is given in FIG. 1. Such a transmission system comprises a transmitter 1 having a content server 2, a receiver 3 having a reception buffer 5 and a content player 7, and a transmission channel 9. The content server 2 stores data files F1, . . . , Fi, . . . , FN.

Both the transmitter 1 and the receiver 3 support a transport protocol with rate control, and a transport protocol without rate control.

A transport protocol with rate control estimates the channel available bandwidth from information received from the receiver, generates target output bit rates from these estimations, and controls the transmission times of the data to enforce said target output bit rates.

In contrast, a transport protocol without rate control does not control the transmission times of the data. When a transport protocol without rate control is used, the output bit rate is set by the application APPL.

For instance, the transport protocol with rate control is the TCP protocol (Transmission Control Protocol), and the transport protocol without rate control is the UDP protocol (User Datagram Protocol). Typically, TCP and UDP run via the IP protocol.

Both the transmitter 1 and the receiver 3 also support on top of said transport protocols the Real-time Transport Protocol (RTP) defined in the RFC 1889 by the IETF (Internet Engineering Task Force). The aim of the RTP protocol is to provide end-to-end transport functions suitable for applications transmitting real-time data, such as audio or video. The RTP protocol comprises a control protocol (RTCP) that provides control functionalities. RTP and RTCP are designed to be independent of the underlying transport protocols.

As represented in FIG. 2, the receiver 3 is configured to send content requests R to the transmitter 1, and the transmitter 1 is configured to respond to such requests by sending a data file Fi containing the requested content encoded at a certain encoding rate.

The operation of the transmission system represented in FIG. 1 will now be described with reference to FIG. 3. According to FIG. 3, the transmission of a data file containing a content of known duration P from the transmitter 1 to the receiver 3 is achieved by:
using the transport protocol with rate control (for example, TCP) during a first period of time T1 while storing the received data in the reception buffer 5 of the receiver 3,
using the transport protocol without rate control (for example, UDP) during a second period of time T2,
starting the rendering of the received data at the beginning of the second period of time.

The receiver 3 has the ability to detect the change of transport protocol by watching the received packets (for instance, it has the ability to detect whether the packets are TCP packets or UDP packets). Optionally, the transmitter 1 notifies the receiver 3 when it switches from the downloading mode to the streaming mode by sending an RTCP packet to the receiver 3. Such a notification may be used as a starting signal by the content player 7.

In the first embodiment of the invention, the client specifies in his request R the data file he wants to receive.

For a given data file, the switching point between the first and the second period of time is determined from an estimation of the channel transmission rate so that the second period of time is proportional to the known duration of the content, with a proportionality factor K smaller than or equal to one.

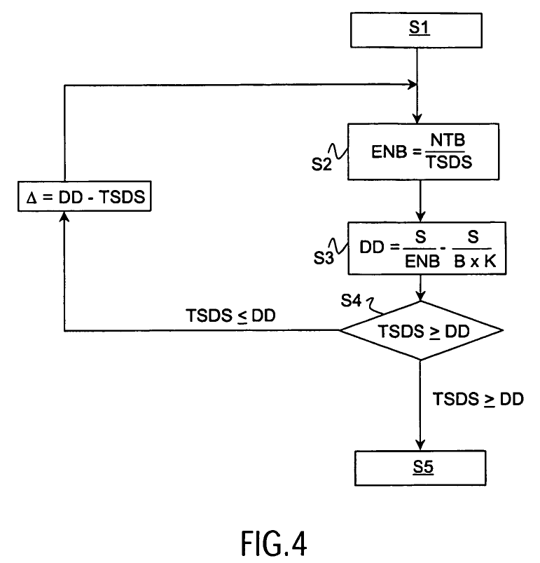

The determination of the switching point from the downloading mode to the streaming mode will now be described with reference to FIG. 4. According to FIG. 4:
at step S1, the downloading of the data file starts.
at step S2, the current transmission rate of the channel ENB is estimated:

$$ENB = \frac{NTB}{TSDS}$$

where
NTB is the number of bytes that have already been transmitted
TSDS is the time (in seconds) since the download started
at step S3, an estimation DD of the first period of time is calculated:

$$DD = \frac{S}{ENB} - \frac{S}{B \times K}$$

where
S is the size of the data file (in bytes)
B is the encoding rate of the content for the data file to be transmitted (in bytes/s)

$$P = \frac{S}{B}$$

is the duration of the content (in seconds), K is a proportionality factor smaller than or equal to one.
at step S4, the time since download started TSDS is compared with the estimation of the first period of time DD. If it is higher than or equal to the estimation of the first period of time, the transmitter switches to the streaming mode (step S5). If it is lower than the estimation of the first period of time, the transmitter waits a certain time Δ before returning to step S2. For example, Δ=DD−TSDS.
at step S5, the rest of the data file is streamed.

An example will now be given to illustrate the invention. If B=5 kB/s,

$$P = \frac{S}{B} = 300 s ,$$

S=1,5 MB, for a network bit rate equal to 4 kB/s, the duration of the first period of time will be 75 s. It can be seen from that example that the invention allows transmission of a data file having a bit rate of 5 kB/s through a transmission channel having a bit rate of 8 kB/s. The latency introduced in that case is equal to 75 s only.

In the second embodiment of the invention, the client specifies in his request R an authorized latency time LT, and the server selects the data file to be transmitted depending on this authorized latency time, and on an estimation of the channel transmission rate ENB:

$$B \approx ( \frac{LT}{P} + \frac{1}{K} ) \times ENB$$

where the sign <<≈>> means <<near>>

In order to select the data file to be transmitted, the server first has to make an estimation of the effective channel transmission rate. This is achieved by sending learning data to the receiver:
either by using the transport protocol with rate control,
or by using the transport protocol without rate control at a transmission rate which is higher than the supposed channel transmission rate, and using control information sent back by the receiver (for example, via RTCP packets) to estimate the effective channel transmission rate.

Once the data file to be transmitted has been selected, the effective duration of the first period of time is:
either calculated as described above with reference to FIG. 4 for the first embodiment of the invention,
or fixed to the authorized latency indicated in the client's request.

The above described transmission method is preferably implemented by means of sets of instructions being executable under the control of computers or digital processors located at the transmitter and at the receiver.

It is to be noted that, with respect to the described method, receiver, transmitter and transmission network, modifications or improvements may be proposed without departing from the scope of the invention. The invention is thus not limited to the examples provided.

Use of the verb “comprise” and its conjugations does not exclude the presence of elements or steps other than those stated in the claim.

1. A transmission system comprising a transmitter, a receiver having a content player, and a transmission channel between said transmitter and said receiver, said transmission channel having a channel transmission rate, said transmitter and said receiver supporting a transport protocol with rate control and a transport protocol without rate control, said transmitter and said receiver being configured such that, for transmission from said transmitter to said receiver of a data file containing a content of known duration encoded at an encoding rate which is higher than said channel transmission rate, they use said transport protocol with rate control during a first period of time while storing the received data, and said transport protocol without rate control during a second period of time while playing the received data, said second period of time being proportional to said known duration, with a proportionality factor smaller than or equal to one.

2. A transmission system as claimed in claim 1, wherein said receiver is configured to send a request for a specific data file, and said transmitter is configured to:
calculate estimations of said channel transmission rate during said first period of time,
calculate estimations of said first period of time from said estimations of the channel transmission rate,
terminate said first period of time when the estimation of said first period of time is substantially equal to the time passed since the beginning of the transmission of said data file.

3. A transmission system as claimed in claim 1, wherein said receiver is configured to send a request for a content, said request indicating an authorized latency time, and said transmitter is configured to:
send learning data to said receiver for calculating an estimation of said channel transmission rate,
select the data file to be transmitted, from said estimation of the channel transmission rate and from said authorized latency time.

4. A transmitter supporting a transport protocol with rate control and a transport protocol without rate control, said transmitter being configured such that, for transmission via a transmission channel having a channel transmission rate of a data file containing a content of known duration encoded at an encoding rate which is higher than said channel transmission rate, it uses said transport protocol with rate control during a first period of time, and said transport protocol without rate control during a second period of time, said second period of time being proportional to said known duration, with a proportionality factor smaller than or equal to one.

5. A transmitter as claimed in claim 4, further configured such that, when receiving a request for a specific data file, it:
calculates estimations of the channel transmission rate during said first period of time,
calculates estimations of said first period of time from said estimations of the channel transmission rate,
terminates said first period of time when the estimation of said first period of time is substantially equal to the time passed since the beginning of the transmission of said data file.

6. A transmitter as claimed in claim 4, further configured such that, when receiving a request for a content, which request indicates an authorized latency time, it:
sends learning data to said receiver for calculating an estimation of said channel transmission rate,
selects the data file to be transmitted, from said estimation of the channel transmission rate and from said authorized latency time.

7. A receiver having a content player and supporting a transport protocol with rate control and a transport protocol without rate control, said receiver being configured such that, for reception via a transmission channel having a channel transmission rate of a data file containing a content of known duration encoded at an encoding rate which is higher than said channel transmission rate, it uses said transport protocol with rate control during a first period of time while storing the received data, and said transport protocol without rate control during a second period of time while playing the received data, said second period of time being proportional to said known duration, with a proportionality factor smaller than or equal to one.

8. A receiver as claimed in claim 7, further configured to send a request for a content, said request indicating a value for said first period of time.

9. A transmission method for transmitting, via a transmission channel having a channel transmission rate, a data file containing a content of known duration encoded at an encoding rate which is higher than said channel transmission rate, said transmission method comprising the steps of:
transmitting data using a transport protocol with rate control during a first period of time, while storing the received data,
transmitting data using a transport protocol without rate control during a second period of time, while playing the received data, said second period of time being proportional to said known duration, with a proportionality factor smaller than or equal to one.

10. A program comprising instructions for implementing a transmission method as claimed in claim 9, when executed by a processor.
